(19) United States
(12) Patent Application Publication
(10) Pub. No.: US 2012/0029139 A1
(43) Pub. Date: Feb. 2, 2012

(54) BLOCK COPOLYMERS HAVING ASSOCIATIVE GROUPS, AND ADHESIVE CONTAINING SAME

(75) Inventors: Nicolas Dufaure, Bernay (FR); Manuel Hidalgo, Brignais (FR); Aurelie Grange, Pont Saint Vincent (FR); Francois-Genes Tournilhac, Paris (FR); Ludwik Leibler, Paris (FR)

(73) Assignees: CENTRE NATIONAL DE LA RECHERCHE SCIENTIFIQUE (CNRS, PARIS (FR); ARKEMA FRANCE, COLOMBES (FR)

(21) Appl. No.: 13/147,228

(22) PCT Filed: Jan. 29, 2010
(86) PCT No.: PCT/FR10/50150

§ 371 Date: Oct. 17, 2011

(30) Foreign Application Priority Data
Jan. 30, 2009 (FR) 0920576

(51) Int. Cl. C09J 153/00

(52) U.S. Cl. 524/533; 525/299; 525/314

(57) ABSTRACT

The present invention relates to a hot-melt adhesive that comprises a block copolymer having associative groups containing a nitrogen heterocyclic compound. The invention also relates to block copolymers having associative groups specifically adapted for implementation in a hot-melt adhesive

The present invention relates to block copolymers carrying associative groups based on nitrogenous heterocycles and to hot-melt adhesives comprising such a copolymer.

Hot-melt adhesives are thermoplastic materials which are solid at ambient temperature and which become viscous liquids when heated. These viscous liquids are applied to a first substrate and then it is covered with a second surface. On cooling, adhesion between the substrate and the second surface is obtained. The open assembly time is the period during which the adhesive which has been applied to a substrate, which is generally at ambient temperature, remains tacky, that is to say the interval of time during which it is possible to apply the second surface and, on cooling, to obtain adhesion between the substrate and the second surface. Once this time limit for the open assembly time has been exceeded, it is no longer possible to obtain sufficient adhesion between the substrate and the second surface. These adhesives are denoted by the abbreviation HMA (hot-melt adhesives). The present invention relates to adhesives of this type.

Adhesives having an infinite open assembly time are of use for self-adhesive labels or adhesive tape which are used at ambient temperature. Depending on the nature of the adhesive, it is possible to obtain more or less strong adhesions and, for example, to detach and reattach the label. Bonding is achieved by pressure, often at ambient temperature, hence the name for this category of adhesives, which are referred to as “pressure-sensitive” or PSA (pressure-sensitive adhesives). The adhesive is deposited on the substrate (for example label or tape), either while hot, in the absence of any solvent, or while cold, in the presence of a liquid vehicle which can be a solvent (solvent-based adhesives) or water (water-based adhesives). When pressure-sensitive adhesives are applied without a liquid vehicle, while hot, that is to say at a temperature such that the adhesive flows, these adhesives are denoted by the term HMPSA (hot-melt pressure-sensitive adhesives). They are also sometimes denoted as self-adhesive hot-melt compositions. The present invention also relates to adhesives of this type.

These hot-melt adhesive compositions generally comprise two main constituents: a thermoplastic polymer (responsible for the good mechanical and thermal properties and for at least a portion of the adhesive properties) and a tackifying resin which plays a part in improving the hot tack, the flowability or the wettability. Generally, a number of additives are added thereto, such as plasticizers, including oils, or waxes, stabilizers or fillers. Waxes (for example paraffin waxes) make it possible to adjust the flowability, the open assembly time and the setting time. Mention may be made, among the most widely used thermoplastic polymers, of ethylene/vinyl acetate, ethylene/alkyl (meth)acrylate or styrene/butadiene/styrene copolymers, atactic poly-α-olefin (APAO), thermoplastic rubber, polyamide and others. Tackifying resins belong chiefly to three main families: rosins (and their derivatives), terpene resins and petroleum-derived resins (aliphatic resins, aromatic resins and the like).

The inventors have shown that the use of a block copolymer carrying associative groups based on nitrogenous heterocycle makes it possible to improve the hot adhesion between two supports.

In particular, the inventors have shown that a specific copolymer carrying associative groups based on nitrogenous heterocycle exhibits an improved resistance to shearing as a function of the temperature in comparison with the same copolymers not carrying associative groups.

Thus, such a copolymer provides the hot-melt adhesive comprising it with an improved adhesion or even an adhesion similar to that of the adhesives of the prior art on applying the adhesive according to the invention at a lower temperature. This copolymer can also make it possible to reduce the amount of tackifying resin to be added in order to obtain an equivalent level of adhesion. These associative groups can also confer a better mechanical strength and chemical resistance on the adhesive.

A subject matter of the invention is thus a hot-melt adhesive, comprising a block copolymer carrying associative groups based on nitrogenous heterocycle.

Preferably, said copolymer comprises:
from 1 to 99% of at least one flexible block, and
from 1 to 99% of at least one rigid block.

Flexible block is understood to mean, within the meaning of the present invention, a block for which the Tg is lower than ambient temperature by at least 10° C.

The term “carrying” means, within the meaning of the present invention, that the block copolymer and the associative groups are bonded via one or more covalent bonds.

Rigid block is understood to mean, within the meaning of the present invention, a block for which the Tg is greater than ambient temperature by at least 20° C. Tg denotes the measured glass transition temperature of a polymer, which can, for example, be measured by DSC according to the standard ASTM E1356. By misuse of language, it is also possible to speak of the Tg of a monomer in order to denote the Tg of the homopolymer having a number-average molecular weight Mn of at least 10 000 g/mol obtained by polymerization of said monomer. Thus, sentences can be found where it is said that ethyl acrylate has a Tg of −24° C. because homopoly(ethyl acrylate) has a Tg of −24° C. All the percentages are given by weight, unless otherwise mentioned.

Preferably, the block copolymer is composed of a central block B with a Tg<0° C. and of at least two rigid side blocks A and A′ with a Tg>40° C. In accordance with the definition given in 1996 by the IUPAC in its recommendations on the nomenclature of polymers, block copolymer denotes a copolymer composed of adjacent blocks which are constitutionally different, that is to say of blocks comprising units derived from different monomers or from the same monomers but according to a different composition or a different sequential distribution or a different spatial configuration of the units. A block copolymer can, for example, be a diblock copolymer, a triblock copolymer or a star copolymer.

The block copolymer is, for example, a triblock copolymer A-B-A′ comprising a flexible central block B connected via covalent bonds to two rigid side blocks A and A′ (that is to say, positioned on each side of the central block B), it being possible for A and A′ to be identical or different (this type of copolymer is also sometimes denoted A-b-B-b-A′).

Preferably, the block copolymer is such that the rigid side block(s) and the block B are incompatible, that is to say that they exhibit a Flory-Huggins interaction parameter χ_{AB}>0 at ambient temperature. This results in phase microseparation with formation of a two-phase structure at the microscopic scale. The block copolymer is then nanostructured, that is to say that domains are formed having a size of less than 100 nm, preferably of between 10 and 50 nm. The nanostructuring exhibits the advantage of resulting in a highly transparent material, whatever the temperature.

The block copolymer can be obtained using polymerization techniques known to a person skilled in the art. One of these polymerization techniques can be anionic polymerization, such as is, for example, taught in the following documents FR 2 762 604, FR 2 761 997 and FR 2 761 995. It is also possible for the controlled radical polymerization technique to be involved, which technique comprises several alternative forms depending on the nature of the control agent which is used. Mention may be made of SFRP (stable free radical polymerization), which uses nitroxides as control agents and can be initiated by alkoxyamines, ATRP (atom transfer radical polymerization), which uses metal complexes as control agent and is initiated by halogenated agents, or RAFT (reversible addition-fragmentation transfer), which for its part involves sulfur-comprising products, such as dithioesters, trithiocarbonates, xanthates or dithiocarbamates. Reference may be made to the general review Matyjaszewski, K. (Ed.), ACS Symposium Series (2003), 854 (Advances in Controlled/Living Radical Polymerization), and to the following documents for further details with regard to the controlled radical polymerization techniques which can be used: FR 2 825 365, FR 2 863 618, FR 2 802 208, FR 2 812 293, FR 2 752 238, FR 2 752 845, U.S. Pat. No. 5,763,548 and U.S. Pat. No. 5,789,487.

In order to obtain a triblock copolymer ABA′ using the controlled radical polymerization technique, use may advantageously be made of a difunctional alkoxyamine of formula T-Z-T where the T groups are nitroxides and the z group is a difunctional initiating group capable of generating two initiating radicals. The starting action is a preparation of the central block B by polymerizing, using the alkoxyamine, the mixture of monomers resulting in the central block, which can be described according to the notation employed above as T-B-Z-B-T. The polymerization takes place with or without solvent, or else in dispersed medium. The mixture is heated to a temperature greater than the activation temperature of the alkoxyamine. When the central block B is obtained, the monomer(s) resulting in the side blocks is (are) added. It may be that, on conclusion of the preparation of the central block, there remain monomers which have not been entirely consumed, which it may or may not be chosen to remove before the preparation of the side blocks. The removal can consist, for example, in precipitating from a nonsolvent, recovering and drying the central block. If the choice is made not to remove the monomers which have not been entirely consumed, the latter may polymerize with the monomers introduced in order to prepare the side blocks. Examples of the preparation of block copolymers by controlled radical polymerization will be found in the following documents WO 2006/053984 or WO 03/062293. When the polymerization begins with the formation of the block B, the two side blocks A and A′ are identical in terms of composition and of average molecular weight (the block copolymer thus has the formula ABA).

As regards the central block B, the latter exhibits a Tg<0° C. The number-average molecular weight Mn is between 10 000 and 1 000 000 g/mol, preferably between 10 000 and 50 000 g/mol (with respect to a PMMA standard). The proportion by weight of the central block B in the block copolymer is between 5 and 90%.

As regards the side blocks A and A′, these exhibit a Tg>40° C.

The copolymer of the invention can be functionalized with monomers carrying associative groups introduced during the copolymerization; it can also be grafted with associative groups after the polymerization stage. The copolymer of the invention confers, on the adhesive compositions of which it forms part, a very good cohesive and adhesive behavior as a function of the temperature.

Preferably, the adhesive according to the invention additionally comprises at least one tackifying resin.

This adhesive is generally deposited while hot over a substrate.

Tackifying resins which are suitable are, for example, rosin, rosin esters, hydrogenated rosin, polyterpenes and derivatives, aromatic or aliphatic petroleum resins or hydrogenated cyclic resins. These resins typically have a ring-and-ball softening temperature between 25° C. and 180° C. and preferably between 50° C. and 135° C.

Other examples of rosin derivatives are described in Ullmann's, Vol. A 23, pp. 79-86.

Mention may be made, as rosin derivatives, of those obtained by hydrogenation, dehydrogenation, polymerization or esterification. These derivatives can be used as is or in the form of polyol esters, such as pentaerythritol, polyethylene glycol and glycerol esters.

Mention may also be made, as tackifying resin, of dicyclopentadienes.

The presence of a copolymer carrying associative groups in the adhesive which is a subject matter of the invention makes it possible to improve the adhesion and the shaping of the adhesive. It is therefore possible to obtain a bonding at a lower temperature for the same effectiveness, in comparison with an adhesive not comprising such a copolymer. This makes it possible to reduce the amount of tackifying resin to be used in order to have the desired properties.

Thus, in a preferred embodiment of the invention, the adhesive comprises from 1 to 70 parts of resin per 100 parts of the mixture of copolymer and resin and preferably from 20 to 50 parts of resin per 100 parts of the mixture of copolymer and resin.

The adhesives which are subject matters of the invention can additionally comprise one or more plasticizers as additive.

The plasticizers which can be used in the adhesives of the invention are, for example, paraffinic, aromatic or naphthenic mineral oils. They are used essentially to lower the viscosity and to contribute tack. The amount of plasticizer can be between 10 and 30 parts per 100 parts of the mixture of adhesive.

Mention may also be made, as plasticizer, of phthalates, azelates, adipates, tricresyl phosphate and polyesters.

The adhesives of the invention can also comprise fillers and stabilizers as additives.

Mention may be made, as example of fillers, of silica, alumina, glass, glass beads, calcium carbonates, fibers and metal hydroxides. These fillers must not be so much as to reduce the tack or the mechanical or adhesive properties of the adhesive after the application thereof. The amount of fillers can represent up to 100 parts per 100 parts of adhesive.

It is recommended to add stabilizers, such as antioxidants. Use may be made of the normal antioxidants for thermoplastics.

The hot-melt adhesives of the invention are prepared by melt blending at temperatures of between 130° C. and 200° C. until a homogeneous mixture is obtained. The mixing time can be of the order of from 30 minutes to 3 hours. Use may be made of the normal devices for processing of thermoplastics, such as internal mixers, extruders or rolls.

Another subject matter of the present invention is a block copolymer, comprising:
at least one block A composed of monomers including:
   (i) at least one methacrylate of formula CH₂—C(CH₃)—COOR₁, where R₁ is a linear or branched C₁-C₃ alkyl group, a branched C₄ group, a C₃-C₈ cycloalkyl group, a C₆-C₂₀ aryl group, a C₇-C₃₀ arylalkyl group including a C₁-C₄ alkyl group, a heterocyclic group or a heterocyclylalkyl group including a C₁-C₄ alkyl group, these groups optionally being substituted by one or more identical or different groups chosen from hydroxyl and halogen groups, and/or
   (ii) at least one styrene monomer, such as styrene, which is optionally hydrogenated, and
at least one block B including:
   (i) at least one alkyl acrylate of formula CH₂—CH—COOR₂, where R₂ is a linear or branched C₁-C₁₂ alkyl group optionally substituted by one or more identical or different groups chosen from hydroxyl and halogen groups, and/or
   (ii) at least one methacrylate of formula CH₂—C(CH₃)—COOR₃ where R₃ is a linear C₄-C₁₂ alkyl group or a branched C₅-C₁₂ alkyl group, and/or
   (iii) a diene monomer, such as butadiene or isoprene; this monomer may optionally have been hydrogenated after the polymerization;
      said block copolymer carrying an associative group based on nitrogenous heterocycle.

“Block copolymer” is understood to mean, according to the invention, a linear or star block copolymer or, by extension, a gradient copolymer. This copolymer is considered as a separate entity, in the self-supported form, and not as a structure grafted to another (co)polymer, such as the shell of a core-shell system conventionally used as impact modifier.

Preferably, the copolymer according to the invention has an overall polydispersity index PI=Mw/Mn (where Mw is its weight-average molecular weight and Mn is its number-average molecular weight) ranging from 1 to 10 and preferably from 1.05 to 2.5.

The block A of the block copolymer according to the invention preferably has a glass transition temperature of greater than 40° C. It can, for example, comprise at least one monomer chosen from: styrene and α-methyl-styrene, which are optionally hydrogenated, methyl methacrylate, ethyl methacrylate, propyl methacrylate, isopropyl methacrylate, isobutyl methacrylate, tert-butyl methacrylate or their mixtures.

According to a preferred embodiment of the invention, the block A comprises, indeed is even predominantly composed of, styrene monomer units.

According to a preferred embodiment of the invention, the block A comprises, indeed is even predominantly composed of, methyl methacrylate monomer units.

In addition, it is possible for the block A to comprise, in addition to the methacrylate or styrene, at least one dialkylacrylamide monomer, the linear or branched alkyl groups of which independently include from 1 to 10 carbon atoms, such as N,N-dimethyl-acrylamide.

As far as the block B is concerned, it preferably has a glass transition temperature of less than 0° C. and more preferably of at most −10° C.

The block B can thus comprise at least one monomer chosen from n-butyl acrylate, 2-ethylhexyl acrylate, hydroxyethyl acrylate, 2-ethylhexyl methacrylate, n-octyl acrylate, butadiene, isoprene or another diene monomer, and their mixtures.

According to a preferred embodiment of the invention, the block B comprises, indeed is even predominantly composed of, n-butyl acrylate and/or 2-ethylhexyl acrylate monomers and optionally, less preferably, hydroxyethyl acrylate, 2-ethylhexyl methacrylate, n-octyl acrylate or their mixtures.

According to a preferred embodiment of the invention, the block B comprises, indeed is even predominantly composed of, diene monomers, such as butadiene and/or isoprene. These monomers can be hydrogenated after the polymerization.

A particularly preferred example of a block copolymer according to the invention is a copolymer based on methyl methacrylate/n-butyl acrylate/methyl methacrylate blocks. Another particularly preferred example of a block copolymer according to the invention is a copolymer based on styrene/n-butyl acrylate/styrene blocks. Another particularly preferred example of a block copolymer according to the invention is a copolymer based on styrene/butadiene/styrene blocks.

### Associative Groups

“Associative groups” is understood to mean groups capable of associating with one another via hydrogen, ionic and/or hydrophobic bonds. According to a preferred form of the invention, the groups are ones capable of associating via hydrogen bonds, comprising a nitrogenous heterocycle, preferably a dinitrogenous heterocycle, generally comprising 5 or 6 atoms. Examples of associative groups which can be used according to this preferred form of the invention are imidazolidonyl, triazolyl, triazinyl, bis-ureyl or ureido-pyrimidyl groups. The imidazolidinyl group is preferred.

### Functionalization or Grafting of the Copolymer

According to one embodiment of the invention, the associative groups can be introduced during the formation of the copolymer. This embodiment is not limiting, it also being possible for a reactive extrusion of a mixture of associative groups with the preformed block copolymer to be envisaged.

### Introduction During the Polymerization

The copolymers which are the subject matters of the invention carry associative groups based on nitrogenous heterocycle. These associative groups can be present both on the blocks A and on the blocks B or solely on just one type of block A or B.

One way of modifying the base copolymers, so that they carry associative groups based on nitrogenous heterocycle, is the functionalization of the polymer during the polymerization thereof using functional monomers capable of copolymerizing and therefore of being thus inserted into the actual backbone of the polymer chains while carrying said associative groups based on nitrogenous heterocycle. When this method of functionalization by copolymerization is chosen in order to obtain the block copolymer carrying associative groups according to the invention, the functional monomers carrying the associative groups are introduced, during the polymerization, as a mixture with the monomers used to construct the block copolymer. Thus, for example, in the case of a block copolymer according to the invention of ABA type, the functional monomers carrying the associative groups can be introduced as a mixture with the monomer or monomers constituting the blocks A and/or as a mixture with the monomer or monomers constituting the block B.

Mention may be made, as examples of monomers which make possible the introduction of imidazolidonyl groups into the polymer, of ethylimidazolidone methacrylate and ethylimidazolidonemethacrylamide.

The copolymer which is the subject matter of the invention can thus be obtained by controlled radical polymerization in the presence of a nitroxide, as described in the application WO 03/062293.

Such a process can comprise the successive stages of:

1—preparing a monoalkoxyamine starting from a nitroxide, as described in particular in the application WO 2004/014926,
2—preparing a polyalkoxyamine, in particular a dialkoxyamine, starting from the monoalkoxyamine obtained in stage 1, for example by reaction with an α,ω-diol comprising ends esterified by a carboxyvinyl compound, such as (meth)acrylic acid,
3—preparing the block B by polymerization of the corresponding monomers in the presence of the polyalkoxyamine obtained in stage 2, up to a degree of conversion preferably of less than 90; optionally removing the residual monomers or polymerizing the latter by conventional radical polymerization techniques,
4—mixing the block B thus obtained with the monomers intended to form the block A,
5—preparing the block A by using the block B as polymerization initiator, and
6—removing or polymerizing by conventional radical polymerization techniques the residual monomers which may be present in the copolymer thus obtained.

When the residual monomers of the blocks A and/or B are removed by polymerization using well known conventional radical polymerization techniques, the amounts of conventional radical initiator, such as, for example, an organic peroxide or an azo compound, and the polymerization conditions, such as, for example, the temperature, have to be chosen so as to ensure that the conventional radical homopolymers of the monomers A and/or B have molecular weights such that they will be predominantly incorporated in the corresponding blocks A and/or B of the block copolymer prepared by controlled radical polymerization, according to the above description. This is necessary in order to prevent the chains of conventional homopolymers A and/or B obtained from the residual monomers of the block polymerization from forming new phases separate from the phases A and B of the block copolymer, which would result in a morphological modification which may be reflected by a poorer adhesive performance of the final adhesive composition. The nitroxides used in this process correspond, for example, to the formula (III) below:

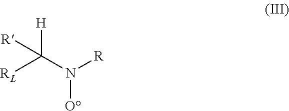

in which:
R and R′, which are identical or different and which are optionally connected so as to form a ring, denote C₁-C₄₀ alkyl groups optionally substituted by one or more hydroxyl, alkoxy or amino groups, R and R′ preferably denoting, independently, an unsubstituted C₁-C₁₀, more preferably C₁-C₆, alkyl group, such as a tert-butyl group, and
R_{L} denotes a monovalent group with a molar mass of greater than 16 g/mol, such as a dialkyl phosphonate group and in particular a diethyl phosphonate group.

In addition, the block copolymer which can be used according to the invention can be obtained commercially from Arkema under the trade name Nanostrength®.

### Grafting

In another embodiment of the invention, the copolymer which is a subject matter of the invention can be obtained by grafting associative groups to a block copolymer already formed comprising at least one reactive functional group, such as an acid, anhydride, alcohol, mercaptan, amine, epoxy or isocyanate functional group, preferably an anhydride functional group, by reaction of one or more modifying agents carrying, on the one hand, an associative group and, on the other hand, a reactive group chosen from amine, mercaptan, epoxy, isocyanate, anhydride or alcohol groups, preferably an amine group, said reactive group being capable of forming a covalent bond with said reactive functional group.

The anhydride functional group carried by the copolymer can be obtained in two ways. It can be introduced either during the polymerization, with a monomer preferably of maleic anhydride type, or after the polymerization; this method of obtaining is described subsequently. The addition of anhydride during the polymerization is preferred; when this route is not possible or possible only with difficulty, the formation of anhydride on the polymer is chosen.

### Introduction or Formation of Anhydrides

In this embodiment, anhydrides are grafted to the copolymer. The copolymer can, for example, be a styrene/butadiene/styrene block copolymer where the soft block has been hydrogenated. Maleic anhydride is subsequently grafted to this soft block by radical reaction using, for example, peroxides. This reaction can be carried out in an extruder.

In this other embodiment, anhydrides are formed on the copolymer. The copolymer carrying reactive functional groups can, for example, be a methyl methacrylate/butyl acrylate/methyl methacrylate (also denoted MMA/BUA/MMA) block copolymer including anhydride functional groups. This block copolymer can be obtained from a block copolymer of alkyl (meth)acrylate, in particular methyl (meth)acrylate, and of butyl (meth)acrylate, functionalized with (meth)acrylic acid, for example including between 0.5 and 15 mol % of (meth)acrylic acid units. Such a block copolymer functionalized with (meth)acrylic acid is subsequently treated in order to obtain the anhydride functional groups according to a cyclization process, preferably under basic catalysis conditions, which can in particular be carried out in an extruder. The preferred basic catalysts include sodium hydroxide and sodium methoxide, CH₃ONa. The cyclization can be carried out by passing the starting copolymer through a single- or twin-screw extruder with the catalyst and optionally other additives, such as lubricants, antioxidants or colorants; the extrusion temperature can be between 200 and 300° C. and preferably greater than 250° C. One or more extrusion passes can be carried out in order to obtain the desired level of cyclization (formation of glutaric anhydride). The degree of cyclization can be controlled in order to adjust the content of anhydride functional groups obtained, which can, for example, range from 0.1 to 20 mol % per block comprising the anhydride functional groups.

### Modifying Agents

The reactive and associative groups respectively of the modifying agent can be separated by a rigid or flexible chain composed of from 1 to 30 carbon atoms, some at least of which can be substituted, and optionally of one or more heteroatoms chosen in particular from sulfur, oxygen and nitrogen, said chain optionally including one or more ester or amide bridges. The chain is preferably a linear or branched C₁-C₁₀ alkylene chain optionally interrupted by one or more nitrogen atoms, more preferably a linear C₁-C₆ alkylene chain.

The modifying agent can thus correspond to any one of the formulae (B1) to (B4):

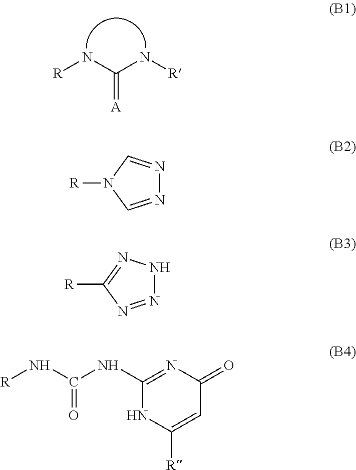

where:
R denotes a unit comprising at least one reactive group,
R′ denotes a hydrogen atom,
R″ denotes a hydrogen atom or any group,

A denotes an oxygen or sulfur atom or an ═NH group, preferably an oxygen atom.

Preferred examples of modifying agents are 2-amino-ethylimidazolidone (UDETA), 1-(2-[(2-aminoethyl)amino]-ethyl)imidazolidone (UTETA), 1-(2-[2-{2-aminoethyl-amino}ethylamino]ethyl)imidazolidone (UTEPA), N-(6-aminohexyl)-N′-(6-methyl-4-oxo-1,4-dihydro-pyrimidin-2-yl)urea (UPy), 3-amino-1,2,4-triazole (3-ATA) and 4-amino-1,2,4-triazole (4-ATA). UDETA is preferred for use in the present invention.

Some of these compounds can be obtained by reaction of urea with a polyamine. For example, UDETA, UTETA and UTEPA can respectively be prepared by reacting urea with diethylenetriamine (DETA), triethylenetetraamine (TETA) and tetraethylenepentaamine (TEPA).

The number of associative groups carried by the copolymer in this embodiment according to the invention can be simply adjusted by varying the amount of modifying agent or the reaction time and reaction temperature. It is generally preferable for the amount of modifying agent to represent from 0.1 to 15% by weight, more preferably from 0.5 to 5% by weight, with respect to the weight of the copolymer carrying reactive functional groups, and/or for the mean number of associative groups per copolymer chain to be between 1 and 200 and preferably between 1 and 30.

In a preferred embodiment of the invention, the mean number of associative groups per copolymer chain is greater than or equal to 3, preferably between 3 and 200 and entirely preferably between 3 and 30.

The grafting process is carried out by reacting the modifying agent and the copolymer carrying reactive functional groups. This stage can be carried out in the molten state, for example in an extruder or an internal mixer, at a temperature which can range from 100° C. to 300° C., preferably from 150° C. to 280° C. and even from 200° C. to 280° C. The modifying agent is blended with the polymer, alone or using an additive which makes possible the impregnation of the solid polymer grains by the premelted modifying agent. The solid blend, before introduction into the extruder or the mixer, can be rendered more homogeneous by cooling in order to cause the modifying agent to solidify. It is also possible to meter the latter into the extruder or the mixer after the polymer to be grafted has started to melt. The time at the grafting temperature can range from a few seconds to 5 minutes. The modifying agent can be introduced into the extruder in the form of a masterbatch in a polymer which can be the polymer to be grafted. According to this method of introduction, the masterbatch can comprise up to 30% by weight of the modifying agent; subsequently, the masterbatch is “diluted” in the polymer to be grafted during the grafting operation. According to another possibility, the grafting can be carried out by reaction in a solvent phase, for example in anhydrous chloroform. In the latter, the reaction temperature can range from 5° C. to 75° C., for times ranging from a few minutes to a day, and at concentrations of polymer before grafting of between 1 and 50% by weight, with respect to the total weight of the solution. Depending on the solvent chosen, the temperature of the grafting reaction can vary between 5° C. and 150° C. and preferably between 25° C. and 100° C.

It has been demonstrated that the copolymer which is a subject matter of the invention makes it possible to improve the hot adhesion between two supports.

Another subject matter of the present invention is thus the use of a copolymer carrying associative groups as described above for improving the cohesive and adhesive behavior as a function of the temperature of the adhesive compositions in which it is included, making it possible to result in a very good thermal stability.

Thus, a copolymer carrying associative groups as described above can be used to improve the adhesion and/or the shaping of the adhesive; in other words, a bonding is obtained at a lower temperature for the same effectiveness, which makes it possible to reduce the amount of tackifying resin to be used in order to have the desired properties.

The addition of these associative groups can also make it possible to improve the cohesion of the adhesives and to render the layer of adhesive stronger, in order, for example, to limit the tearing thereof when a stress is applied. Unlike the known crosslinked adhesives, the adhesive which is the subject matter of the present invention can be reshaped at high temperature by virtue of its thermally reversible bonds. These associative groups can also confer, on the adhesive, a better resistance to solvents.

Another subject matter of the present invention is the use of an adhesive as described above in the manufacture of labels or of adhesives for binding two sheets or layers of paper together or else one sheet or layer of paper with another object, such as a bag made of plastic or of plastic-coated paper, of structural or repairing hot-melt adhesives which can be used in the construction industry, do-it-yourself, the manufacture of objects, including hygiene articles, such as disposable diapers or towels, also including constituent parts of vehicles, boats or airplanes, also including articles of clothing or decoration, such as shoes, clothes, furniture and decorative objects, including office automation articles, such as paper carriers or lamps, and also any other application requiring the assembly of two surfaces without the use of a liquid vehicle (water or solvent). It will also be possible, by virtue of the hot-melt adhesives of the invention carrying associative groups, to produce bondings on difficult supports, such as cardboard and/or floor coverings.

A better understanding of the invention will be obtained in the light of the following examples, given solely for the purposes of illustration and which do not have the aim of restricting the scope of the invention defined by the appended claims.

### EXAMPLES

### Example 1

### Preparation of a Copolymer According to the Invention

### 1A—Preparation of the Block Copolymer

### Preparation of 2-methyl-2-[N-(tert-butyl)-N-(1-di-ethoxyphosphoryl-2,2-dimethylpropyl)aminoxy]propionic acid

500 ml of degassed toluene, 35.9 g of CuBr (250 mmol), 15.9 g of copper powder (250 mmol) and 86.7 g of N,N,N′,N″,N″-pentamethyldiethylenetriamine or PMDETA (500 mmol) are introduced into a 2 l glass reactor purged with nitrogen and then a mixture comprising 500 ml of degassed toluene, 42.1 g of 2-bromo-2-methyl-propionic acid (250 mmol) and 78.9 g of 84% SG1 (Arkema) (225 mmol), having the formula:

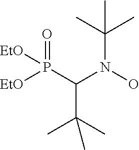

is introduced with stirring and at ambient temperature (20° C.)

Reaction is allowed to take place for 90 min at ambient temperature and with stirring and then the reaction medium is filtered. The toluene filtrate is washed twice with 1.5 l of a saturated aqueous NH₄Cl solution.

A yellowish solid is obtained, which solid is washed with pentane in order to give 51 g of 2-methyl-2-[N-(tert-butyl)-N-(1-diethoxyphosphoryl-2,2-dimethyl-propyl)aminoxy]propionic acid (yield: 60%). The structure is in particular confirmed by mass spectrometry and ¹H NMR spectrometry.

### Preparation of a Dialkoxyamine

2 g of the monoalkoxyamine obtained as described above, 0.52 g of 1,4-butanediol diacrylate with a purity >98% (1 equ.) and 6.7 ml of ethanol are introduced into a 100 ml round-bottomed flask purged with nitrogen. The mixture is heated at reflux at 78° C. for 20 h and then the ethanol is evaporated under vacuum. 2.5 g of a highly viscous yellow oil are obtained.

The ³¹P NMR analysis shows the complete disappearance of the monoalkoxyamine (27.4 ppm) and the appearance of the dialkoxyamine (multiplet at 24.7-25.1 ppm). The analysis by mass spectrometry of electrospray type reveals a weight of 961 (M+).

### Preparation of the Block Copolymer

The synthesis is carried out in 2 stages:
1st stage: Bulk preparation of a living poly(n-butyl acrylate) polymer

146 g of butyl acrylate, 7.68 g of methacrylic acid and 3.93 g of the dialkoxyamine obtained as described above are introduced into a 2 l polymerization reactor equipped with a variable-speed stirrer motor, with inlets for the introduction of the reactants, with branch pipes for the introduction of inert gases which make it possible to drive off the oxygen, with probes for measuring the temperature, with a system for condensation of vapors with reflux and with a jacket which makes it possible to heat/cool the contents of the reactor by virtue of the circulation in the jacket of a heat-exchange fluid. After degassing several times with nitrogen, the reaction medium is brought to 115° C. and this temperature is maintained by thermal regulation for several hours.

Samples are taken throughout the reaction in order to:
determine the polymerization kinetics by gravimetric analysis (measurement of solids content),
monitor the change in the number-average molecular weight (Mn) as a function of the conversion of the monomer to polymer.

When a conversion of 70% is reached, the reaction medium is cooled to 60° C. and the residual butyl acrylate is removed by evaporation under vacuum.

The molecular weights of the poly(n-butyl acrylate) as polystyrene equivalent are 49 090 g/mol for Mp (peak molecular weight), 35 090 g/mol for Mn (number-average molecular weight) and 49 830 g/mol for Mw (weight-average molecular weight).
2nd stage: Reinitiating the living poly(n-butyl acrylate) with methyl methacrylate

478 g of methyl methacrylate and 1028.7 g of toluene, which are degassed beforehand, are added at 60° C. to the poly(n-butyl acrylate) prepared above. The reaction medium is then heated at 105° C. for one hour and then at 120° C. for an additional hour. The conversion reached is of the order of 50%. After returning to ambient temperature, the solution of copolymer (methyl methacrylate-b-n-butyl acrylate-b-methyl methacrylate) comprising 50% by weight of n-butyl acrylate is withdrawn from the reactor and the residual monomers and solvents are removed by evaporation under vacuum.

The molecular weights of the copolymer as polystyrene equivalent are 139 800 g/mol for Mn (number-average molecular weight) and 285 192 g/mol for Mw (weight-average molecular weight). The polydispersity index is 2.04.

The copolymer obtained is denoted under the reference “AG07”.

### 1B—Formation of Anhydride

The above copolymer comprises 5% of methacrylic acid in the BUA phase.

This copolymer is placed in an oven under vacuum at 235° C. overnight in order to form anhydrides (reaction between a methacrylic acid unit and a butyl acrylate unit or between two methacrylic acid units).

The copolymer obtained is denoted under the reference “AG12”.

### 1C—Blending of the Block Copolymer with UDETA by Coextrusion

The copolymer prepared as described in example 1B is blended with UDETA under the following conditions: as the grafting reaction between the UDETA and the anhydride formed on the MMA/BUA/MMAs is very fast, the latter is carried out by reactive extrusion on a DSM Research® microextruder.

The experimental protocol is then as follows:

X grams of anhydride-modified MMA/BUA/MMA and Y grams of UDETA are weighed out in an aluminum dish. 3 blends are produced and the amounts of X and Y are respectively: 14.85 g and 0.15 g for a degree of grafting of 1%, denoted under the reference “AG13”; 14.7 g and 0.3 g for a degree of grafting of 2%, denoted under the reference “AG14”; and 14.25 g and 0.75 g for a degree of grafting of 5%, denoted under the reference “AG15”.

In a first step, only the copolymer is introduced into the extruder using a pneumatic piston and is then left to mix for a few minutes.

Once the mixture is very homogeneous, the liquid UDETA is introduced via the open hopper using a pipette. The combined mixture is subsequently left to blend for 6 minutes under the conditions given in the following table 1:

TABLE 1
Temperature profile

| Location of | | |
|---|---|---|
| the probe | Front temperature | Back temperature |
| Top | 220° C. | 220° C. |
| Middle | 220° C. | 220° C. |
| Bottom | 220° C. | 220° C. |

| | |
|---|---|
| Temperature | 210° C. |
| of the melt | |

Speed of the screws: 150 revolutions per minute

### Example 2

### Evaluation of the Mechanical Properties of the Copolymer According to the Invention by Studying the Hot Adhesion (SAFT Test)

### 2A—Protocols of the Tests Carried Out

The SAFT test (ASTM D4498) measures the ability of an HMPSA to withstand a static force of 0.5 kgf under the effect of a steady rise in temperature of 0.4° C./min.

The SAFT is defined by the temperature at which separation, by parallel vertical slippage, may be observed of an area of 25×25 mm², coated with copolymer as obtained in example 1, from a flat sheet of board.

A film of copolymer is pressed at 190° C. for 2 minutes between two sheets of silicone-treated paper under a force of 400 daN. A square of 25×25 mm² is subsequently cut out and placed between two test specimens made of board and pressed at 190° C. under 400 daN for 2 minutes. The test strips had to be conditioned for at least 4 hours before the test in a climate-controlled chamber at 23±2° C. and 50±5% RH. The self-adhesive tape is applied using a standardized standard 2 kg roller.

### 2B—Results Obtained

The results thus obtained are combined in the following table 2:

TABLE 2
Summary of the failure temperatures

| | | Mean failure | Standard |
|---|---|---|---|
| Reference | Composition | temperature | deviation |
| AG 07 | MC 101, | 161° C. | 4.3 |
| (comparative | without UDETA or | | |
| example) | anhydride | | |
| AG 12 | MC 101, | 141° C. | 3.8 |
| (comparative | without UDETA, | | |
| example) | with anhydrides | | |
| AG 13 | MC 101 | Did not drop | / |
| (copolymer | 1% UDETA | | |
| according to | | | |
| the invention) | | | |
| AG 14 | MC 101 | Did not drop | / |
| (copolymer | 2% UDETA | | |
| according to | | | |
| the invention) | | | |
| AG 15 | MC 101 | Did not drop | / |
| (copolymer | 5% UDETA | | |
| according to | | | |
| the invention) | | | |

The oven is heated up to a temperature of 170° C.; the samples for which “did not drop” is mentioned reached this temperature without the two sheets of board becoming detached.

It is observed that the copolymers which are subject matters of the invention exhibit a better hot adhesion between two supports, in comparison with copolymers not in accordance with the invention not carrying an associative group based on nitrogenous heterocycle.

1. A hot-melt adhesive, comprising a block copolymer carrying associative groups based on nitrogenous heterocycle.

2. The adhesive as claimed in claim 1, wherein said copolymer comprises:
from 1 to 99% of at least one flexible block, and
from 1 to 99% of at least one rigid block.

3. The adhesive as claimed in claim 1, wherein the associative group is chosen from an imidazolidonyl, triazolyl, triazinyl, bis-ureyl or ureido-pyrimidyl group, preferably an imidazolidinyl group.

4. The adhesive as claimed in claim 1, further comprising at least one tackifying resin.

5. The adhesive as claimed in claim 1, further comprising an additive chosen from a plasticizer, a filler, a stabilizer and their mixtures.

6. A block copolymer, comprising:
at least one block A composed of monomers including:
(i) at least one methacrylate of formula CH₂—C(CH₃)—COOR₁, where R₁ is a linear or branched C₁-C₃ alkyl group, a branched C₄ group, a C₃-C₈ cycloalkyl group, a C₆-C₂₀ aryl group, a C₇-C₃₀ arylalkyl group including a C₁-C₄ alkyl group, a heterocyclic group or a heterocyclylalkyl group including a C₁-C₄ alkyl group, these groups optionally being substituted by one or more identical or different groups chosen from hydroxyl and halogen groups, and/or
(ii) at least one styrene monomer, such as styrene, which is optionally hydrogenated,
and
at least one block B including:
(i) at least one alkyl acrylate of formula CH₂—CH—COOR₂, where R₂ is a linear or branched C₁-C₁₂ alkyl group optionally substituted by one or more identical or different groups chosen from hydroxyl and halogen groups, and/or
(ii) at least one methacrylate of formula CH₂—C(CH₃)—COOR₃ where R₃ is a linear C₄-C₁₂ alkyl group or a branched C₅-C₁₂ alkyl group, and/or
(iii) a diene monomer, such as butadiene or isoprene;
said block copolymer carrying an associative group based on nitrogenous heterocycle.

7. The copolymer as claimed in claim 6, wherein the block A comprises methyl methacrylate monomers.

8. The copolymer as claimed in claim 6, wherein the block B comprises at least one monomer chosen from n-butyl acrylate, 2-ethylhexyl acrylate, hydroxyethyl acrylate, 2-ethylhexyl methacrylate, n-octyl acrylate and their mixtures.

9. The copolymer as claimed in claim 6, wherein the copolymer is a methyl methacrylate/n-butyl acrylate/methyl methacrylate block copolymer.

10. The copolymer as claimed in claim 6, wherein the block A comprises styrene monomers.

11. The copolymer as claimed in claim 6, wherein the block B comprises butadiene and/or isoprene monomers.

12. The copolymer as claimed in claim 6, wherein the copolymer is a styrene/butyl acrylate/styrene block copolymer.

13. The copolymer as claimed in claim 6, wherein the mean number of associative groups per copolymer chain is between 1 and 200 and preferably between 1 and 30.

14. An adhesive comprising the copolymer as claimed in claim 6.

15. A method for improving the melt behavior of a hot-melt adhesive and/or its adhesion to supports, comprising introducing therein a block copolymer as defined in claim 6.
